(19) United States
(12) Patent Application Publication
(10) Pub. No.: US 2006/0280579 A1
(43) Pub. Date: Dec. 14, 2006

(54) Plastic tolerance compensating assembly

(76) Inventors: Jorg Seidl, Schwanstetten (DE); Uwe Klein, Steinwenden (DE); Hans-Ulrich Figge, Schloss-Holte (DE); Wolfgang Hesse, Rietberg (DE)

Correspondence Address: SEYFARTH SHAW LLP, 131 S. DEARBORN ST., SUITE2400, CHICAGO, IL, 60603-5803, US

(21) Appl. No.: 11/449,304

(22) Filed: Jun. 8, 2006

(30) Foreign Application Priority Data
Jun. 8, 2005 (DE) 20 2005 009 017.4

(51) Int. Cl. F16B 43/02

(52) U.S. Cl. 411/546

(57) ABSTRACT

A tolerance compensating assembly of automatically compensating tolerances in the spacing between two structural members comprises a mounting bolt 10, a base element 4, an adjustment sleeve 6 and a driver 8. The base element 4 and the adjustment sleeve 6 form a first thread pairing G1 of a predetermined spiral direction for adjusting the adjustment sleeve 6 relative to the base element 4. The base element 4 and the mounting bolt 10 form a second thread pairing G2 in the opposite spiral direction for clamping the two structural members B1, B2. The driver 8 is a separate structural member and disengageably connected to the adjustment sleeve 6 and has a plurality of flexibly resilient clamping portions 34 spaced along its periphery, which provide for frictional contact with the thread of the mounting bolt 10 above a predetermined torsional force.

### BACKGROUND OF THE INVENTION

The present invention relates to a tolerance compensating assembly for automatically compensating tolerances in the spacing between two pre-mounted structural members or structural members to be mounted which are to be clamped together.

A great number of such tolerance compensating assemblies are known, see for example EP 0 176 663 B1, DE 42 24 575 C2, DE 101 51 383 A1, DE-GM 201 190012 and DE-GM 203 14 003. They serve in compensating the tolerance between pre-mounted structural members which ensues in manufacturing and/or mounting. To this end, these tolerance compensating assemblies normally comprise an adjustment sleeve having a so-called drive portion which can enter into frictional contact connection with a mounting bolt. Upon rotating the mounting bolt, the adjustment sleeve is therefore also rotated until it is fixedly supported against one of the structural members to be clamped, whereupon given further rotation of the mounting bolt and the corresponding increase in torsional force, the frictional contact connection is overcome such that both structural members can be clamped together in the adjustment sleeve by the mounting bolt.

The tolerance compensating assemblies known from the prior art normally consist either wholly or partly of metal elements, wherein the non-metallic elements are made of e.g. a thermoplastic synthetic. These known tolerance compensating assemblies are relatively expensive and those which make use of thermoplastic synthetics have the disadvantage of the clamping between the two structural members diminishing due to the relaxation of the plastic.

### SUMMARY OF THE INVENTION

It is the object of the present invention to provide a tolerance compensating assembly for automatically compensating tolerances in the spacing between two pre-mounted structural members which are to be clamped together which can be manufactured economically and of a configuration suitable for manufacturing from plastic.

This object is solved by the tolerance compensating assembly defined in claim 1.

In addition to a base element and an adjustment sleeve, the tolerance compensating assembly configured according to the invention also comprises a driver configured as a separate structural member and disengageably connected to the adjustment sleeve. Said driver exhibits a plurality of flexibly resilient clamping portions spaced along its periphery which form a disengageable frictional contact connection with the thread of the mounting bolt above a given torsional force.

Since the driver, which performs the frictional drag function necessary for compensating tolerance, is a separate structural member, manufacturing the individual components of the tolerance compensating assembly is relatively simple. The invention furthermore enables a “complete plastic solution” in which both the base element and the adjustment sleeve as well as the driver are made of plastic.

In particular, the invention offers the possibility of manufacturing the base element and the adjustment sleeve from a low-relaxation plastic such as e.g. a duromer plastic. Since these materials have a relaxation of almost zero, the two structural members remain securely clamped even after lengthy use and even under high pressures. However, a different type of plastic could in principle also be used such as e.g. a thermoplastic material.

The driver is preferably made of a flexibly resilient plastic such as e.g. a thermoplastic synthetic, in order to enter into frictional contact connection with the thread of the mounting bolt and thus be able to perform the frictional drag function.

The base element, the adjustment sleeve and the driver preferably form a pre-mountable structural unit which can be stored, transported and otherwise handled as such.

Further developments and modifications of the invention are defined in the sub-claims.

### BRIEF DESCRIPTION OF THE DRAWINGS

The drawings will be used to describe an exemplary embodiment of the invention in greater detail. Shown is:

FIG. 1 is a perspective view of a structural unit of a tolerance compensating assembly configured according to the invention in the pre-mounted state;

FIG. 2 is a perspective exploded view of the structural unit from FIG. 1;

FIG. 3 is a longitudinal section through the structural unit of FIG. 1 in the visual direction of the III-III arrow in FIG. 4;

FIG. 4 is a plan view of the structural unit of FIGS. 1 and 3;

FIG. 5 is a side view of the structural unit from the preceding figures;

FIG. 6 is a sectional view in the visual direction of the VI-VI arrow in FIG. 5;

FIG. 7 is an enlarged view of Detail B from FIG. 6;

FIG. 8 is a sectional view of the tolerance compensating assembly in the visual direction of the VIII-VIII arrow in FIG. 10 prior to assembly;

FIG. 9 is a sectional view of the tolerance compensating assembly corresponding to FIG. 8 after assembly;

FIG. 10 is a plan view of the tolerance compensating assembly from FIGS. 8 and 9.

### DETAILED DESCRIPTION OF THE PREFERRED EMBODIMENT

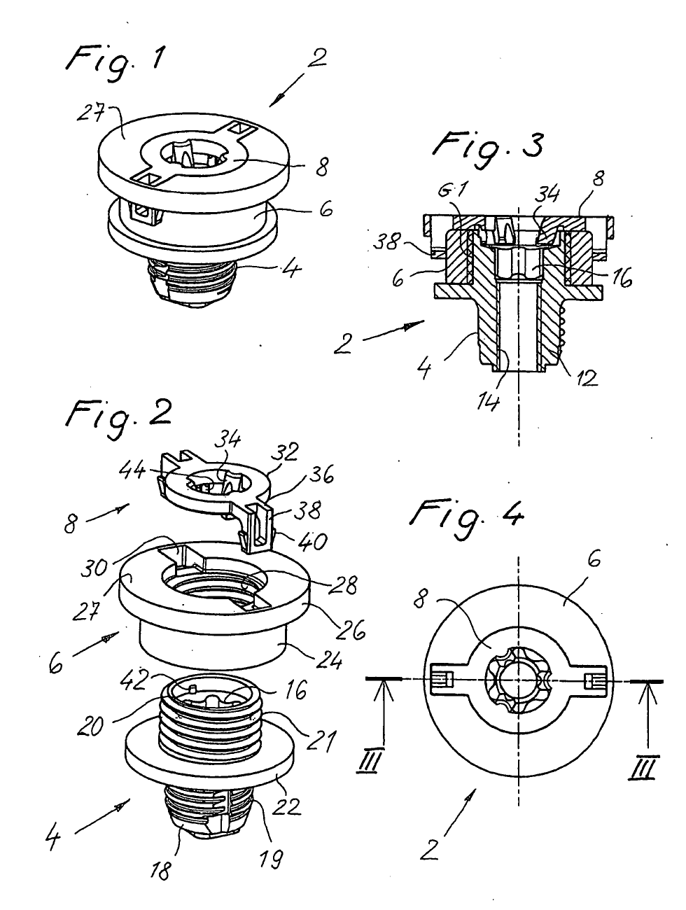

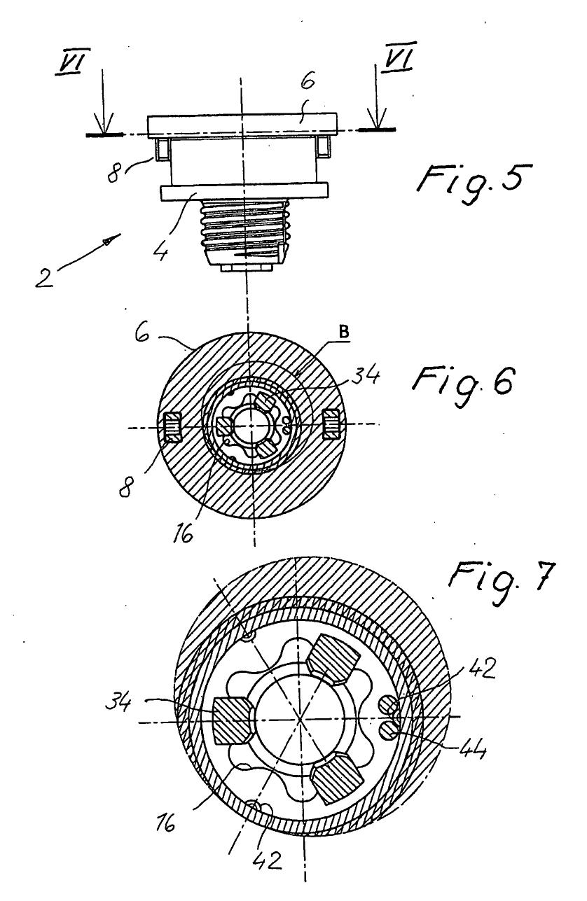

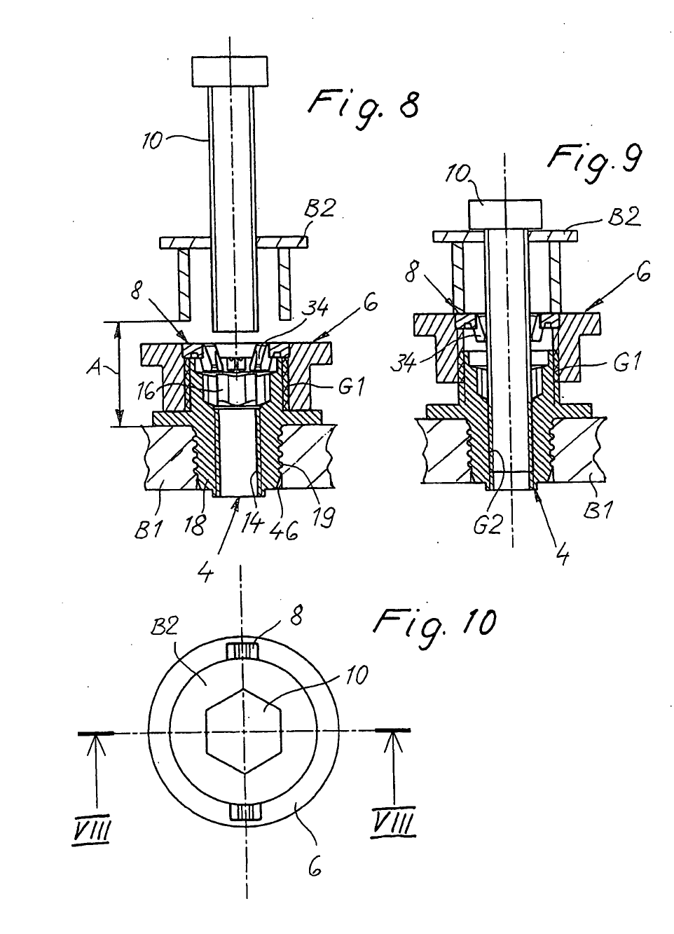

FIGS. 1 to 7 show a structural unit 2 for a tolerance compensating assembly as depicted in FIGS. 8 to 10. The structural unit 2, which forms the tolerance compensating assembly together with a conventional mounting bolt 10 (FIGS. 8, 9), consists of a base element 4, an adjustment sleeve 6 and a driver 8, as can especially be seen in FIG. 2.

The base element 4 (see FIGS. 2 and 3 in particular) consist of a sleeve-shaped body 12 having a throughbore disposed with an internal thread 14 and, adjacent thereto, a drive feature 16 for attachment of a tool (not shown). The drive feature 16 is configured as an internal six-lobe recess head in the exemplary embodiment as shown but may, however, also be of a different configuration.

The sleeve-shaped body 12 consists of a mounting portion 18 and an adjustment portion 20, separated by an annular flange 22. The mounting portion 18 has a thread 19 at its outer periphery in the exemplary embodiment shown and serves to fix the base element 4 to a first structural member B1 (FIGS. 8, 9), as will be explained in greater detail below.

The adjustment portion 20 is provided with an adjustment thread 21 at its outer periphery which is engageable with adjustment sleeve 6 as will likewise be explained in greater detail below.

The adjustment sleeve 6 is essentially configured as a hollow cylindrical body 24 having a flange 26 fitted to an axial end of said hollow cylindrical body 24. The body 24 exhibits a throughbore disposed with a thread 28, which forms a first thread pairing G1 together with adjustment thread 21 of the base element 4 (FIG. 9). The adjustment sleeve 6 is provided with slots 30 through the flange 26, the shape of which is adapted to the shape of the driver 8 such that it can receive the driver 8.

The driver 8 is configured as an annular body 32 having a plurality of clamping projections 34 extending radially inwardly spaced along its inner periphery. Three clamping projections 34 are provided in the exemplary embodiment as shown; however a greater or lesser number of clamping projections is also possible.

The annular body 32 is furthermore provided with two diametrically opposing, radially outwardly extending brackets 36, which give way at their outer ends to axial retaining extensions 38 perpendicular thereto. The retaining extensions 38 have a U-shaped profile and are provided with a retention tab 40 on both peripherally opposing sides, as can readily be seen in FIG. 2.

The structural unit 2 comprised of the base element 4, the adjustment sleeve 6 and the driver 8 is pre-assembled. To this end, the driver 8 is inserted from above into the slot 30 of adjustment sleeve 6. The shape of the driver 8 and the shape of the slot 30 compliment one another such that the annular body 32 with the brackets 36 is completely received by the adjustment sleeve 6, enabling the top of the driver 8 to be aligned flush with or slightly set into the face side 27 of the adjustment sleeve 6 (see FIG. 1). The retaining extensions 38 of the bracket 36 have a certain elasticity due to their U-shaped profile such that the retention tabs 40 snap in under the base of the flange 26 upon the driver 8 being inserted into the adjustment sleeve 6, whereby the driver 8 is disengageably held in the adjustment sleeve 6.

The adjustment sleeve 6 together with the driver 8 is now screwed to the adjustment portion 20 of the base element 4, wherein the thread 28 of the adjustment sleeve 6 and the adjustment thread 21 of the base element 4, as mentioned above, form the first thread pairing G1 (FIGS. 8, 9). In the exemplary embodiment as shown, the adjustment thread 21 of the base element is configured as an external threading and the thread 28 of the adjustment sleeve 6 is configured as an internal threading. The base element 4 and the adjustment sleeve 6 could instead also be structurally configured such that the adjustment thread of the base element is an internal threading and the associated thread of the adjustment sleeve 6 is an external threading.

As can especially be seen in FIGS. 2, 6 and 7, the base element 4 and the driver 8 are provided with locking means in the form of nubs 42, 44 as a securing device, providing a locking of the adjustment sleeve 6 relative to the base element 4. More specifically, the base element is provided with three nubs 42 spaced over its periphery, which each can latch engageably between two axially-extending nubs 44 of the driver 8. Using three nubs 42 spaced over the periphery enables at a thread pitch of 1.5 mm, for example, a retention force of between 0 and maximum 0.5 mm. Using a different number of nubs 42 is, of course, also to be understood.

As mentioned at the outset, the individual components of the structural unit 2 are all made of plastic. The base element 4 and the adjustment sleeve 6 are advantageously comprised of a hard, low-relaxation plastic, more preferably a duroplastic synthetic such as e.g. PF6771 phenol resin material. Duroplastic materials have the advantage of very low relaxation. Depending upon application, however, a different material such as e.g. a thermoplastic synthetic can also be used.

The driver 8 is advantageously comprised of a thermoplastic synthetic which lends sufficient elasticity to the clamping projections 34 to exert a frictional drag function. Conceivable here would be, for example, a glass fiber-reinforced polyamide such as e.g. PA6GF50.

The assembly and operation of the tolerance compensating assembly will now be described with reference to FIGS. 8 to 10. The tolerance compensating assembly serves to clamp the structural members B1 and B2, depicted in their preassembled state. The structural members B1 and B2 have a spacing A which can vary in size due to manufacturing and/or mounting tolerances. An appropriate tolerance compensation must therefore be made when clamping the two structural members B1 and B2.

The structural unit 2 is first connected to the structural member B1 by screwing the mounting portion 18 into the structural member B1. In the exemplary embodiment shown, the thread 19 of the mounting portion 18 is configured as a known per se self-tapping and/or grooved thread which forms a corresponding counter-thread in a cylindrical bore 46 of the structural member B1 when the base element 4 is screwed into the structural member B1 with a tool (not shown) via the drive feature 16.

Such a plastic-in-plastic (P-in-P) threaded connection between the base element 4 and the structural member B1 is conceivable when there is a corresponding consistency differential between the structural member B1 and the base element 4. However, instead of this type of P-in-P threaded connection, a different fastening system can also be provided for affixing the base element 4 to the structural member B1.

When the structural unit 2 is fastened to the structural member B1, the mounting bolt 10 is inserted from above through the throughbore of the base element 4 until the clamping projections 34 of the driver 8 frictionally contact the thread of the mounting bolt 10. When the mounting bolt 10 is now rotated, the driver 8 also rotates via the clamping projections 34 and the adjustment sleeve 6 via the driver 8. In the exemplary embodiment depicted, the thread pairing G1 between the base element 4 and the adjustment sleeve 6 is configured as a left-handed thread pairing such that the adjustment sleeve 6 is screwed upward as a result of being driven via the mounting bolt 10 (in FIGS. 8, 9) until the adjustment sleeve 6 is fixedly supported against the structural member B2. If the mounting bolt 10 is turned further, this increases the torsional force, thereby loosening the frictional contact connection between the mounting bolt 10 and the clamping projections 34 of the driver 8. The bolt 10 can now be screwed into the base element 4, wherein the thread of the mounting bolt 10 and the thread 14 of the base element 4 form a second thread pairing G2. This thread pairing is right-handed in the exemplary embodiment as shown; i.e. configured opposite to that of thread pairing G1, so that now both B1 and B2 structural members can be clamped to the structural unit 2 by means of the mounting bolt 10.

As indicated above, there is virtually no relaxation to the materials used for the base element 4 and the adjustment sleeve such that the clamping to the two B1 and B2 structural members also remains intact over the long term and under high pressures.

When the mounting bolt 10 is again disengaged, the adjustment sleeve 6 screws back down into its initial position. When spacing A changes (e.g. upon subsequent leveling of joint sealants), spacing A can then be re-bridged.

In order to be able to easily disengage the adjustment sleeve 6 from the structural element B2, the face side 27 of the adjustment sleeve 6 e.g. exhibits a smooth contact surface which is advantageously limited by an annular outer edge to said face side 27. The rest of the face side is then recessed from this annular contact surface in that it is, for example, configured to be concave.

It is to be understood that the dimensions (length and diameter) of thread pairings G1 and G2 can be varied in order to, depending on use, meet their respective relevant requirements. It is likewise to be understood that thread pairing G1 can also be configured to be right-handed and thread pairing G2 can be configured to be left-handed.

We claim:

1. Tolerance compensating assembly for automatically compensating tolerances in the spacing between two structural members to be clamped together, comprising
a mounting bolt,
a base element, affixable to the first of said two structural members,
an adjustment sleeve which is movable to compensate tolerance in arrangement with the second structural member by an adjustment relative to the base element,
wherein said base element and said adjustment sleeve form a first thread pairing of a predetermined spiral direction for adjusting the adjustment sleeve relative to the base element and the base element and said mounting bolt form a second thread pairing in the opposite spiral direction for clamping said two structural members,
and a driver configured as a separate structural member and disengageably connected to the adjustment sleeve and having a plurality of flexibly resilient clamping portions spaced along its periphery which form a disengageable frictional contact with the thread of mounting bolt above a predetermined torsional force.

2. Tolerance compensating assembly according to claim 1, characterized in that the base element and the adjustment sleeve are made of a low-relaxation plastic, more preferably a duroplast.

3. Tolerance compensating assembly according to claim 1, characterized in that the driver is made of a flexibly resilient plastic, more preferably a thermoplast.

4. Tolerance compensating assembly according to claim 1, characterized in that the driver is configured as annular body and the clamping portions are formed by clamping projections provided on the inner periphery of the annular body.

5. Tolerance compensating assembly according to claim 4, characterized in that radially outwardly extending brackets are fitted to the annular body of the driver which are disengageably connected to the adjustment sleeve by means of snap connections.

6. Tolerance compensating assembly according to claim 5, characterized in that the snap connections are provided by retention tabs on axial retaining extensions of brackets fit to a mating face of the adjustment sleeve.

7. Tolerance compensating assembly according to claim 1, characterized in that the adjustment sleeve is substantially configured as a hollow cylindrical body having a flange fit to one axial end.

8. Tolerance compensating assembly according to claim 1, characterized in that the driver is introduced into a slot of the adjustment sleeve which has a shape corresponding to the shape of the driver.

9. Tolerance compensating assembly according to claim 1, characterized in that the adjustment sleeve is provided with a polished contact surface on a face side for the purpose of fitting to said second structural member.

10. Tolerance compensating assembly according to claim 9, characterized in that the said contact surface of the adjustment sleeve projects slightly relative to the adjacent face side of the driver or is aligned with same.

11. Tolerance compensating assembly according to claim 1, characterized in that the base element has a sleeve-shaped body which has an adjustment thread for said first thread pairing and an internal threading for said second thread pairing.

12. Tolerance compensating assembly according to claim 11, characterized in that said first thread pairing is made of an external threading of the base element and an internal threading of said adjustment sleeve.

13. Tolerance compensating assembly according to claim 11, characterized in that said first thread pairing is made of an internal threading of said base element and an external threading of said adjustment sleeve.

14. Tolerance compensating assembly according to claim 1, characterized in that said base element comprises a mounting portion having a self-tapping and/or formed thread which can be screwed into said first structural member to produce a screwed connection.

15. Tolerance compensating assembly according to claim 14, characterized in that said screwed connection between the base element and the first structural member is a plastic-in-plastic screwed connection.

16. Tolerance compensating assembly according to claim 11, characterized in that said sleeve-shaped body of the base element is provided with a drive feature at its inner periphery for the attachment of a tool.

17. Tolerance compensating assembly according to claim 1, characterized in that the base element, the adjustment sleeve and the driver form a structural unit which can be preassembled.

18. Tolerance compensating assembly according to claim 17, characterized in that the driver and the base element are provided with locking means as a securing device for the structural unit.

19. Tolerance compensating assembly according to claim 18, characterized in that said locking means is made of engaging latching nubs spaced over the periphery of the driver and the base element.

20. Structural unit for a tolerance compensating assembly according to claim 17.
